(19) United States
(12) Patent Application Publication
(10) Pub. No.: US 2013/0244201 A1
(43) Pub. Date: Sep. 19, 2013

(54) Universal Dental Elevator

(71) Applicant: Jang H. Lim, McHenry, IL (US)

(72) Inventor: Jang H. Lim, McHenry, IL (US)

(21) Appl. No.: 13/206,334

(22) Filed: Aug. 9, 2011

(51) Int. Cl. A61C 3/14

(52) U.S. Cl. 433/159

(57) ABSTRACT

A dental elevator for elevating, or loosening a tooth, portion of a tooth, or implant from any position in a mouth. Extending from one handle of the elevator in accordance with this invention is a hook shaped member terminating in a curved sharp edge for engaging the side of a tooth to be elevated or loosened. Extending from the other handle of the elevator in accordance with this invention is a pad, rotationally supported from the handle. The axis about which the pad may rotate 360 degrees is perpendicular both to the major axis of the handle and the plane in which the handles of the pliers lay. By providing two elevators which are mirror images of each other, a tooth, portion of a tooth, or implant may be elevated or loosened from any position within a mouth.

### FIELD OF THE INVENTION

The present invention relates to an elevator for loosening or elevating a tooth or implant.

### BACKGROUND OF THE INVENTION

Pliers type devices have long been used to loosen or remove a tooth from a mouth. Through the years improvements have been made in the configuration of the portions of the pliers engaging the tooth and/or the surrounding tissue to make it more convenient or easier to loosen or remove a tooth or a portion of a tooth. U.S. Pat. No. 354,863, issued on Dec. 21, 1886 to F. G. Hughes shows a dental forceps adapted for extracting certain kinds of roots of teeth. The dental forceps shown in the Hughes patent has a swiveling pad mounted on one part of the forceps and a beak formed on the other part of the forceps. Since the forceps is designed to extract roots of teeth, the swiveling pad would have to engage the gum on one side of the root to be extracted. The pad swivels about a ball-shaped head extending toward the beak on the other part of the forceps. Due to the position of the pad and of the beak with respect to the pliers, the pliers can only be conveniently used with respect to teeth in certain positions within a mouth, and then without any apparent leverage advantage provided by the configuration of the pliers.

A more recent U.S. Pat. No. 6,910,890, issued Jun. 28, 2005 to Richard Golden shows a dental plier with offsetting jaw and pad elements for assisting in removing upper and lower teeth utilizing the dental plier design. A first operating end of the pliers has an arcuately extending jaw with a substantially pointed end. The second operating end has a ergonomic configuration support surface substantially matching that of a patient's gum line opposing and offset from the pointed end of the jaw. Due to the fixed relationship of the support surface and the pointed end, only a limited portion of the support surface will engage the gum line, depending on the positioning of the pliers. FIGS. 4, 5, 10, 11, and 12, show various portions of the support surface engaging the gum, depending on the positioning of the dental pliers shown in the Golden patent. Thus, only a small portion of the support surface engages the gum, thereby applying a greater force to a smaller portion of the gum when the tools is used to extract a tooth. The Golden patent indicates that the dental plier is designed such that the pad engages the gum on the buccal side of the tooth being extracted. Further, four variations of the dental pliers of the Golden patent are required for right and left sides of the upper and lower teeth.

### SUMMARY OF THE INVENTION

It is an object of this invention to provide an elevator which is designed to be used to loosen a tooth, implant, or crown located at any position in a mouth. It is a further object of this invention to provide an elevator having a hook shaped member extending from one handle of the elevator and a pad member extending from the other handle, which pad member may be positioned against either the buccal or the lingual side of the tooth or gum, with the hook shaped member on the opposite side, when elevating or loosening a tooth, implant or crown. It is a still further object of this invention to rotationally support the pad member from the handle, such that it will rotated so as to provide the largest possible surface area of engagement between the pad member and the tooth or gum.

In accordance with this invention an elevator is provide which may be used to loosen a tooth, implant or crown from any position in a mouth, upper or lower, right side or left side. That is, the elevator of this invention can be used both anterial, posterior, lingually or bacally. Extending from one handle of an elevator in accordance with this invention is a hook shaped member terminating in a curved sharp edge, such that two points are formed at the ends of the sharp edge for engaging the side of a tooth, implant or crown to be loosened and extracted. Extending from the other handle of a forceps in accordance with this invention is a pad, rotationally supported from the handle. The pad is provided with a generally flat surface which will rotate to engage the gum or tooth when the elevator is used to loosen and extract a tooth. The axis or rotation of the pad being perpendicular to the major axis of the handle and the plane in which the handles of the elevator lay. The pair of elevators are mirror images of each other.

### BRIEF DESCRIPTION OF THE DRAWINGS

FIG. 1 is a perspective view of a first one of a pair of elevators in accordance with this invention, designed for use in loosening or elevating a tooth, implant or crown from its attachment in a mouth.

FIG. 2 is a perspective view of a second one of a pair of elevators in accordance with this invention, designed for use in loosening or elevating a tooth, implant or crown from its attachment in a mouth.

FIG. 3 is a detailed perspective view of the claw end of one of the arms of the elevator of this invention.

FIG. 4 is a view of one of the elevators of this invention shown positioned to be used to elevate or loosen a tooth from the lower left jaw.

FIG. 5 is a view of one of the elevators of this invention shown positioned to be used to elevate or loosen a tooth from the lower left jaw.

FIG. 6 is a view of one of the elevators of this invention shown positioned to be used to elevate or loosen a tooth from the upper right jaw.

FIG. 7 is a view of one of the elevators of this invention shown positioned to be used to elevate or loosen a tooth from the upper right jaw.

FIG. 8 is an enlarged cross-sectional view of a first way of rotationally attaching a pad to an elevator in accordance with this invention.

FIG. 9 is an enlarged cross-sectional view of a second way of rotationally attaching a pad to an elevator in accordance with this invention.

### DETAILED DESCRIPTION OF THE PREFERRED EMBODIMENT

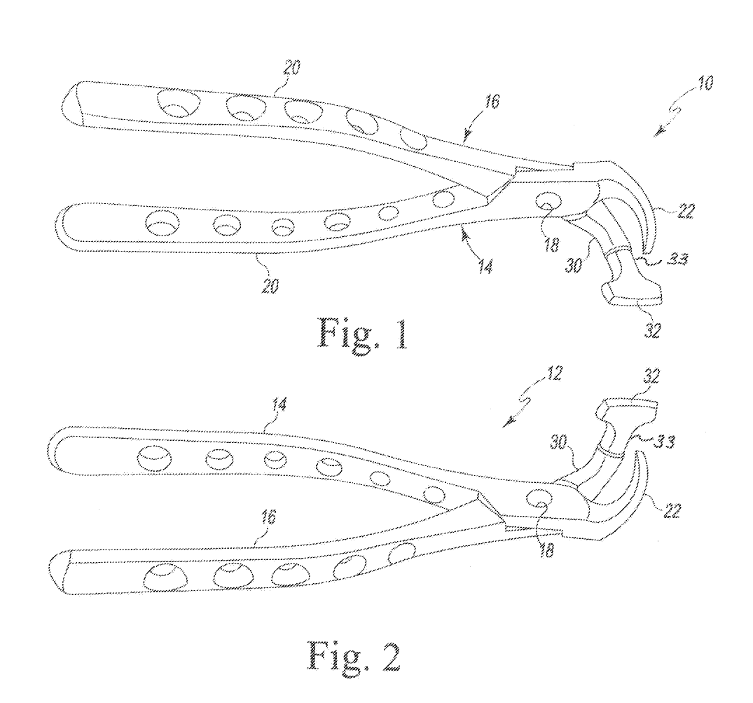

Referring to the FIGS. 1 and 2, a complementary pair of elevators 10 and 12 in accordance with this invention are shown. The elevators 10 and 12, each comprise a first elongated member 14 and a second elongated member 16, pivotally secured to each other at 18. The pivotal connection between the first elongated member 14 and the second elongated member 16 may be formed by a rivet extending through holes in both members, or by a projection on one of the members extending into a hole in the other member. First portions 20 of the first and second elongated members extending from said pivotal connection form handles which are essentially the same, and are shaped to provide for easy grasping by a hand to manipulate the elevator. The central principal axis of the handles lay in a plane.

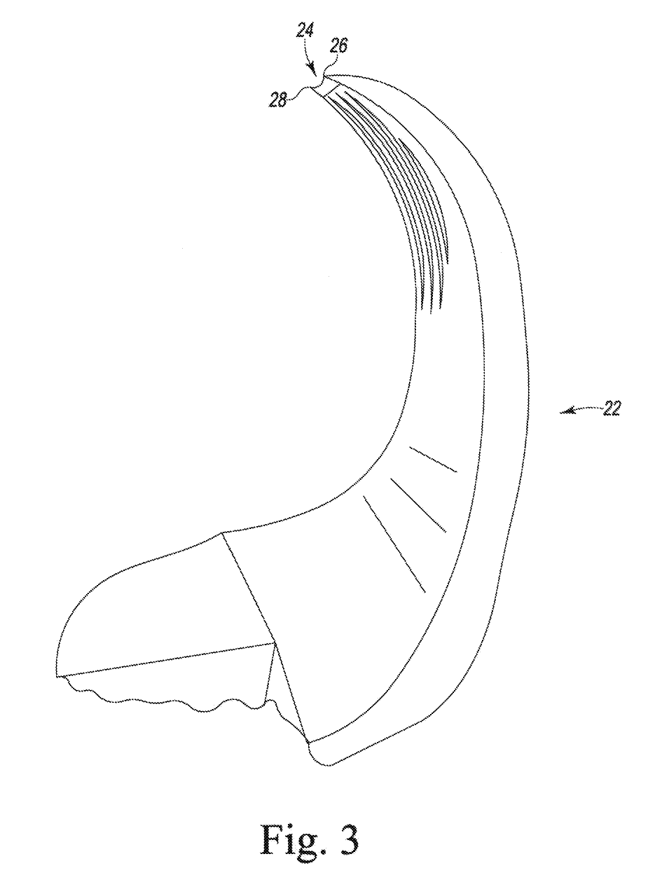

A second portion of the first elongated member 14 is formed as a hook shaped member 22. The hook shaped member 22 extends at essential a right angle to the principal axis of the handle 20 and the plane in which the handles lay, and then curves to the right in elevator 10 and to the left in elevator 12. As shown in FIG. 3, the hook shaped members 22 terminate in a sharp edge 24, having a curved edge, such that two sharp points 26 and 28 are formed for engaging the side of a tooth as will be explained later. The sharp edge 24 along with two sharp points 26 and 28 is commonly called a “bear claw”.

A second portion of the second elongated member 16 is formed with an portion 30 which extends at essentially a right angle to the principal axis of the handle portion 20 and the plane is which the handles lay. A pad member 32 has a projecting portion 33 which is mounted for rotation at the distal end of the portion 30. The pad member rotates about an axis which is essentially at right angles to the major axis of the handle portion 20 and to the plane in which the handles of the pliers lay. In a preferred embodiment of this invention, the pad member may rotate a full 360 degrees with respect to the portion 30. As shown in the preferred embodiment, the pad has a generally rectangular configuration.

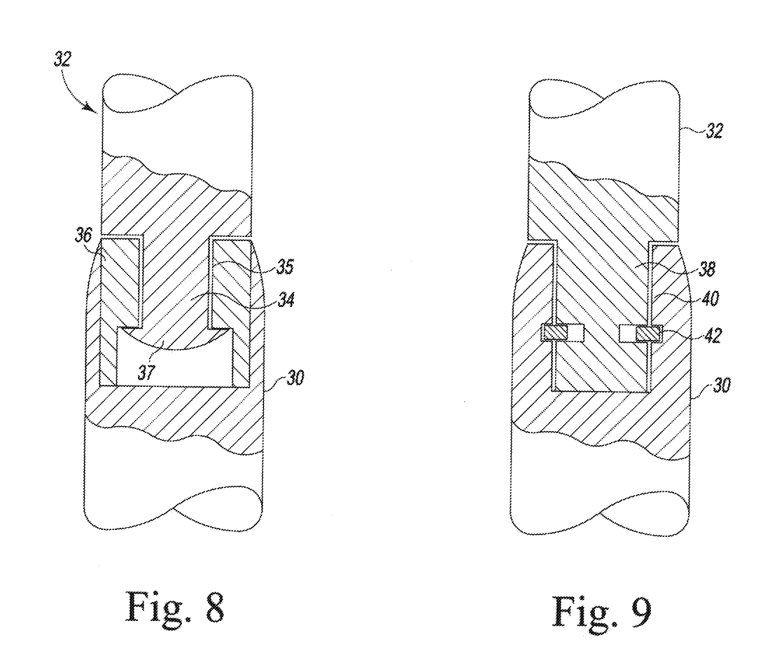

Referring to FIGS. 8 and 9, two arrangements for rotationally mounting the pad member 32 on the portion 30 are shown. As shown in FIG. 8, the pad member 32 is provided with a cylindrical projection 34, which is received in a hole 35 in a bushing 36. The distal end of the cylindrical projection 34 is expanded to form a rivet type head 37 to secure the bushing 36 to the pad member 32. The bushing 36 is received in a hole formed in the distal end of the portion 30, and is secured therein by tightly forming and securing the portion 30 around the bushing 36.

As shown in FIG. 9, a cylindrical projection 38 of the pad member 32 is received in a hole 40 formed in the distal end of the portion 30. Grooves are formed in the cylindrical projection 38 and the hole 40 to receive a snap ring 42, which secures the pad member 32 to the portion 30. Referring to FIGS. 1, 2, 7, and 8, the length portion 30 and the length of projecting portion may be increased or decreased in length with respect to each other and to provide the desired location of the sharp edge 24 of the hook shaped member with respect to the pad.

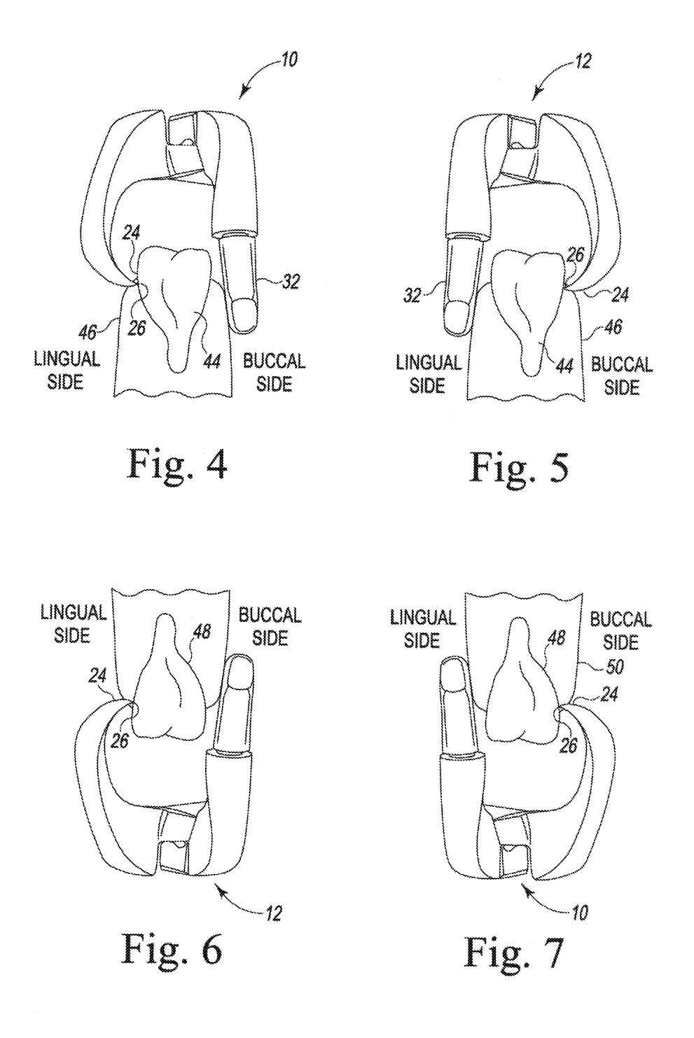

The use of an elevator to elevate or loosen a tooth from the surrounding tissue in a mouth will be described by making reference to FIGS. 4-7. Referring to FIG. 4, a tooth 44 and surrounding tissue 46 on the lower left side of a jaw is shown. The pad member 32 of the elevator 10 shown in FIG. 1 is shown positioned against baccal side of the tooth 44 and surrounding tissue 46. The sharp edge 24 and more particularly the points 26 and 28 engage the buccal side of the tooth 44. As the handle portions are held together, the pad member 32 will rotate to rest with its generally flat surface engaging the baccal side of the tooth 44 and surrounding tissue 46, and the sharp edge 24 and particularly the points 26 and 28 will engage the lingual side of the tooth 44. While the handles are held together, they may be rocked and lifted with respect to the tooth to elevate or loosen and dislodge the tooth from the surrounding tissue.

Referring to FIG. 5, the same tooth 44 and surrounding tissue 46 on the lower left side of a jaw is shown. The pad member 32 of the elevator 12 shown in FIG. 2 is shown positioned against lingual side of the tooth 44 and surrounding tissue 46. The sharp edge 24 and more particularly the points 26 and 28 engage the buccal side of the tooth 44. As the handle portions are held together, the pad member 32 will rotate to rest with its flat surface engaging the lingual side of the tooth 44 and surrounding tissue 46, and the sharp edge 24 and particularly the points 26 and 28 will engage the buccal side of the tooth 44. While the handles are held together, they may be rocked and lifted with respect to the tooth to elevate, loosen or dislodge the tooth from the surrounding tissue in a mouth.

The elevator 12 may be used to elevate or loosen a tooth 48 from the upper right side of a mouth as shown in FIG. 6.

Similarly, the elevator 10 may be used to elevate or loosen the same tooth 48 from the upper right side of a mouth as shown in FIG. 7.

Thus, only a pair of elevators 10 and 12 is required to elevate or loosen or dislodge any tooth in a mouth, upper or lower, right or left side.

While a preferred embodiment of the invention has been shown, it should be apparent to those skilled in the art that what has been shown and described is considered at present to be a preferred embodiment of the dental elevators of this invention. In accordance with the Patent Statute, changes may be made in the dental elevators of this invention without actually departing from the true spirit and scope of this invention. The appended claims are intended to cover all such changes and modifications which fall in the true spirit and scope of this invention.

1. A dental elevator comprising first and second elongated members, and each having first and second portions having respective first and second ends, said first and second elongated members being pivotally attached to each other at a pivot point located between said first and second portions, said pivot point having an axis of rotation, said first portions of said elongated members extending from said pivot point to said first ends forming handles for pivoting said first and second elongated members with respect to each other about said pivot point, second portions of said elongated members extending from said pivot point to said second ends, said second ends extending at an angle to said first portions and further extending roughly parallel to said axis of rotation of said pivot point, a pad rotationally supported on the second end of one of said second portions, a claw facing toward said pad formed on the second end of the other of said second portions, such that said pad may rotate to a position wherein a surface of the pad will engage a first surface on one side of a tooth, and said claw will engage the opposite side of the tooth, whereby when said handles are held together a force may be applied to the tooth, a portion of a tooth or an implant to elevate or loosen a tooth, portion of a tooth or implant.

2. The dental elevator of claim 1, wherein said pad is generally rectangular.

3. The dental elevator of claim 1, wherein said pad may rotate 360 degrees with respect to said second end of said second portion.

4. The dental elevator of claim 1, wherein said claw is formed with a sharp edge for engaging a tooth, a portion of a tooth or an implant.

5. The dental elevator of claim 4, wherein two sharp points are formed at the ends of the sharp edge for engaging a tooth, or a portion of a tooth or an implant.

6. The dental elevator of claim 1, wherein said second ends extend at essentially a right angle to said first portions.

7. A dental elevator comprising first and second elongated members each having first and second ends, and being pivotally attached to each other at a pivot point located between said first and second ends, said pivot point having an axis of rotation, first portions of said elongated members extending from said first ends to said pivot point forming handles for pivoting said elongated members with respect to each other, second portions of said elongated members extending from said second ends to said pivot point, said first portions of each of said elongated members having a central axis passing through said pivot point,
said second portion of said first elongated member extending at an angle to said central axis of said first portion of said first elongated member, said second portion of said first elongated member further extending roughly parallel to said axis of rotation of said pivot point and having a first portion of a rotational connection located at a distal end, a pad having a second portion of said rotational connection extending therefrom,
said second portion of said second elongated member having a tooth engaging member at its distal end extending at an angle to said central axis of said second portion, said second portion of said second elongated member extending roughly parallel to said axis of rotation of said pivot point and facing toward said pad, such that said pad may rotate to a position wherein said pad may engage a first surface on one side of a tooth, and said tooth engaging member engaging the other side of the tooth, whereby when said handles are held together a force may be applied to the tooth or a portion of a tooth to elevate or loosen a tooth, portion of a tooth, or an implant.

8. The dental elevator of claim 7, wherein said pad is generally rectangular.

9. The dental elevator of claim 7, wherein said pad may rotate 360 degrees with respect to said second end of said second portion.

10. The dental elevator of claim 7, wherein said claw is formed with a sharp edge for engaging a tooth, a portion of a tooth, or an implant.

11. The dental elevator of claim 7, wherein said claw is formed with a sharp edge for engaging a tooth, a portion of a tooth, or an implant.

12. The dental elevator of claim 10, wherein two points are formed at the ends of the sharp edge for engaging a tooth, a portion of a tooth, or an implant.

13. A dental elevator comprising first and second elongated members, and each having first and second portions having respective first and second ends, said first and second elongated members being pivotally attached to each other at a pivot point located between said first and second portions, said pivot point having an axis of rotation, said first portions of each of said elongated members having a central axis passing through said pivot point, and laying in a first plane, said first portions extending from said pivot point to said first ends forming handles for pivoting said first and second elongated members with respect to each other about said pivot point, second portions of said elongated members extending from said pivot point to said second ends, said second ends extending at an angle to the first plane and the central axis of said first portions and further extending roughly parallel to said axis of rotation of said pivot point, a pad rotationally supported on the second end of one of said second portions, a claw facing toward said pad formed on the second end of the other of said second portions, such that said pad may rotate to a position wherein a surface of the pad will engage a first surface on one side of a tooth, and said claw will engage the opposite side of the tooth, whereby when said handles are held together a force may be applied to the tooth, portion of a tooth, or implant to elevate, or loosen the tooth, portion of a tooth, or implant.

14. The dental elevator of claim 13, wherein said pad is generally rectangular.

15. The dental elevator of claim 13, wherein said pad may rotate 360 degrees with respect to said second end of said second portion.

16. The dental elevator of claim 13, wherein said claw is formed with a sharp edge for engaging a tooth, a portion of a tooth, or an implant.

17. The dental elevator of claim 16, wherein two sharp points are formed at the ends of the sharp edge for engaging a tooth or a portion of a tooth.

18. The dental elevator of claim 13, wherein said second ends extend at essentially a right angle to said first portions.
